(19) United States
(12) Patent Application Publication
(10) Pub. No.: US 2023/0273993 A1
(43) Pub. Date: Aug. 31, 2023

(54) LOG GENERATION APPARATUS, LOG GENERATION METHOD, AND NON-TRANSITORY COMPUTER READABLE MEDIUM

(71) Applicant: Mitsubishi Electric Corporation, Tokyo (JP)

(72) Inventors: Takumi YAMAMOTO, Tokyo (JP); Kiyoto KAWAUCHI, Tokyo (JP)

(73) Assignee: Mitsubishi Electric Corporation, Tokyo (JP)

(21) Appl. No.: 18/195,133

(22) Filed: May 9, 2023

Related U.S. Application Data
(63) Continuation of application No. PCT/JP2021/000313, filed on Jan. 7, 2021.

(51) Int. Cl. G06F 21/55

(52) U.S. Cl. CPC G06F 21/552; G06F 2221/034

(57) ABSTRACT

A log generation apparatus (100) includes an object search unit (111), a user search unit (112), and a specific operation log generation unit. The object search unit (111) uses a target operation log, which is a log of operations actually performed on objects owned by a target system, to search for a target object from among the objects owned by the target system. The user search unit (112) uses the target operation log to search for, as a target user, a user who can operate the target object from among users of the target system. The specific operation log generation unit receives specific operation information indicating a specific operation that a specific user performs in the target system, and uses the specific operation information and the target operation log to generate a specific operation log, which is a virtual log indicating a specific operation that the target user has performed on the target object.

### CROSS REFERENCE TO RELATED APPLICATION

This application is a Continuation of PCT International Application No. PCT/JP2021/000313, filed on Jan. 7, 2021 which is hereby expressly incorporated by reference into the present application.

### TECHNICAL FIELD

The present disclosure relates to a log generation apparatus, a log generation method, and a log generation program.

### BACKGROUND ART

There is an attack detection technology that uses machine learning to detect an attack by an insider culprit in a system. In this attack detection technology, although learning needs to be performed using data on attacks by insider culprits, it is often not possible to acquire a sufficient amount of data on attacks by insider culprits.

### CITATION LIST

### Non-Patent Literature

Non-Patent Literature 1: Glasser, J., Lindauer, B., “Bridging the Gap: A Pragmatic Approach to Generating Insider Threat Data”, IEEE Security and Privacy Workshops, 2013

### SUMMARY OF INVENTION

### Technical Problem

Non-Patent Literature 1 discloses a technology to generate data on an attack by an insider culprit. However, according to this technology, data on an attack in a simulated environment is generated, so that a problem is that an operation log that cannot realistically occur in an actual environment may be generated.

An object of the present disclosure is to generate a malicious log that can realistically occur in an actual environment.

### Solution to Problem

A log generation apparatus according to the present disclosure is a log generation apparatus in a target system that owns objects, and the log generation apparatus includes
an object search unit to use a target operation log to search for a target object from among the objects owned by the target system, the target operation log being a log of operations actually performed on the objects owned by the target system;
a user search unit to use the target operation log to search for, as a target user, a user who can operate the target object from among users of the target system; and
a specific operation log generation unit to receive specific operation information indicating a specific operation that a specific user performs in the target system, and use the specific operation information and the target operation log to generate a specific operation log, the specific operation log being a virtual log indicating a specific operation that the target user has performed on the target object.

### Advantageous Effects of Invention

A log generation apparatus according to the present disclosure generates a specific operation log based on a target operation log, which is a log of operations actually performed on objects owned by a target system. The specific operation log may be a malicious log. Therefore, according to the present disclosure, a malicious log that can realistically occur in an actual environment can be generated.

### BRIEF DESCRIPTION OF DRAWINGS

FIG. 1 is an example of a configuration of a log generation apparatus 100 according to Embodiment 1;

FIG. 2 is an example of a hardware configuration of the log generation apparatus 100 according to Embodiment 1;

FIG. 3 is a diagram describing internal fraud;

FIG. 4 is a flowchart illustrating operation of the log generation apparatus 100 according to Embodiment 1;

FIG. 5 is a flowchart illustrating operation of an object search unit 111 according to Embodiment 1;

FIG. 6 is a flowchart illustrating operation of a user search unit 112 according to Embodiment 1;

FIG. 7 is a flowchart illustrating operation of a time slot search unit 13 according to Embodiment 1;

FIG. 8 is a flowchart illustrating operation of a malicious log generation unit 121 according to Embodiment 1;

FIG. 9 is a flowchart illustrating operation of a peripheral log generation unit 122 according to Embodiment 1;

FIG. 10 is a flowchart illustrating operation of a log embedding unit 123 according to Embodiment 1;

FIG. 11 is a specific example of an operation log 300 and a virtual fraud log 400 according to Embodiment 1; and

FIG. 12 is an example of a hardware configuration of the log generation apparatus 100 according to a variation of Embodiment 1.

### DESCRIPTION OF EMBODIMENTS

In the description and drawings of embodiments, the same elements and corresponding elements are denoted by the same reference sign. The description of elements denoted by the same reference sign will be suitably omitted or simplified. Arrows its figures mainly indicate flows of data or flows of processing. “Unit” may be suitably interpreted as “circuit”, “step”, “process”, or “circuitry”.

### Embodiment 1

This embodiment will be described in detail below with reference to the drawings.

### Description of Configuration

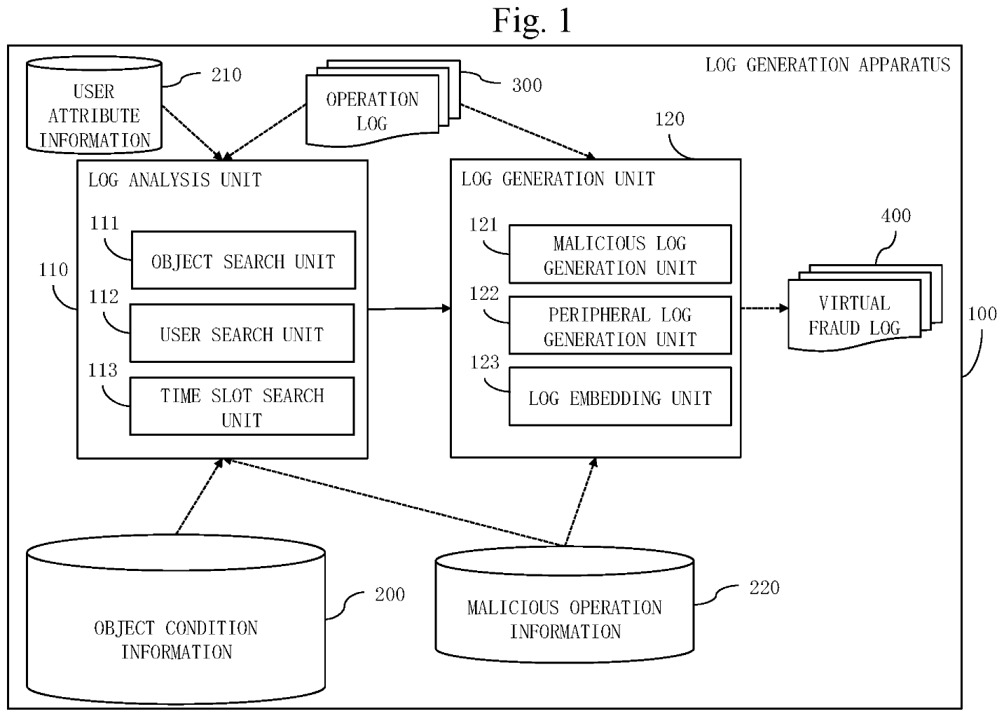

FIG. 1 illustrates an example of a configuration of a log generation apparatus 100 according to this embodiment. As illustrated in this figure, the log generation apparatus 100 includes a log analysis unit 110 and a log generation unit 120, and stores object condition information 200, user attribute information 210, and malicious operation information 220. The log generation apparatus 100 may be used in a client system. A system in which the log generation apparatus 100 is used will be called a target system. The target system owns objects.

An operation log 300 is at least part of a log indicating a history of operations actually performed on the objects owned by the target system by users of the target system, and is also called a target operation log or a client log.

The log analysis unit 110 includes an object search unit 111, a user search unit 112, and a time slot search unit 113.

The object search unit 111 searches for, as a target object, an object on which internal fraud is virtually performed from among the objects owned by the target system. The objects may be any assets that allow user operations on the objects to be monitored by the operation log 300. The objects are, as a specific example, electronic files or electronic devices. Electronic files may be described simply as files. The object search unit 111 may search for a target object based on the degree of confidentiality of each object owned by the target system.

Internal fraud is a malicious operation that a user performs on an object owned by the target system, and is a process indicated by a malicious log 310. Unless otherwise specified, a user refers to a user who uses the target system using an account or the like registered in the target system. As a specific example, the following may constitute internal fraud: a person who has an account in the target system and is an organizational insider browses a file within the scope of privilege given to this person, outputs the file to a USB flash drive within the scope of privilege, and takes the USB flash drive out of the organization. The following may also constitute internal fraud: a person who has an account in the target system and is an organizational insider browses a setting file of an electronic device within the scope of privilege given to this person, and edits the setting file within the scope of privilege so as to induce a failure of the electronic device. A process in which an outsider culprit stoles the account of a legitimate user, uses the stolen account to intrude into the target system from the outside, searches the target system for confidential information within the scope of privilege of the account, and transmits the searched confidential information to the outside is also regarded as internal fraud. In addition, consideration is given to a case where an outsider culprit sends a targeted mail with an attached file containing malware to the personal computer (PC) of a legitimate user, and the legitimate user opens the file attached to the targeted mail, causing the PC of the legitimate user to be infected with the malware. In this case, a process in which the outsider culprit controls the PC of the legitimate user, searches the target system for confidential information within the scope of privilege of the account of the legitimate user, and transmits the searched confidential information to the outside is also regarded as internal fraud. The malicious log 310 is a virtual log indicating a malicious operation that the target user has performed on the target object, and is a log that can be part of the operation log 300. A malicious operation is a normal operation that a malicious user performs on a system. A normal operation is a regular operation that the target user performs on the target system. As a specific example, when an operation is a normal operation and the target user performs this operation, the target system does not judge this operation as an anomalous operation. A judgement as to whether an operation is a normal operation may be made based on a combination of a user operation and a user operation target. As a specific example, when the operation target is a file, a judgement as to whether an operation is a normal operation may be made based on a combination of a user operation on the file and at least one of the confidentiality of the file, the frequency of access to the file, and types of operations frequently performed on the file.

The log generation apparatus 100 can be used also in a power generating plant or the like. In this case, as a specific example, the object search unit 111 treats an electronic device with a high degree of confidentiality as the target object.

The user search unit 112 uses the target operation log to search for, as a target user, a user who can operate on the target object from among users of the target system. The user search unit 112 may use attribute information indicating the attribute of each user to search for the target user.

The time slot search unit 113 searches for a time slot in which the process indicated by the malicious log 310 is performed. The time slot search unit 113 may use the target operation log to search for, as a target time slot, a time slot in which an operation indicated by a specific operation log has been performed.

The log generation unit 120 includes a malicious log generation unit 121, a peripheral log generation unit 122. and a log embedding unit 123.

The malicious log generation unit 121 generates the malicious log 310 based on the malicious operation information 220. The malicious log generation unit 121 is also called a specific operation log generation unit. The malicious log generation unit 121 receives specific operation information that indicates a specific operation performed by a specific user in the target system, and uses the specific operation information and the target operation log to generate a specific operation log, which is a virtual log indicating a specific operation performed on the target object by the target user. A user who performs a malicious operation is also a specific user. A malicious operation is also a specific operation. The malicious log 310 is also a specific operation log. The malicious log generation unit 121 may treat the operation indicated by the specific operation log as having been performed in the target time slot.

The peripheral log generation unit 122 generates a peripheral log 320. The peripheral log 320 is a log similar to the malicious log 310, and is a virtual log indicating a peripheral operation. A peripheral operation is a normal operation performed in the periphery of the location where the target object is stored and performed in a time slot in the periphery of the time slot in which the operation indicated by the malicious log 310 is performed. The peripheral operation is neither a malicious operation nor a specific operation. The peripheral log 320 may be a log that assists the malicious log 310 to become a log that can realistically occur.

The log embedding unit 123 embeds the malicious log 310 and the peripheral log 320 in the operation log 300 to generate a virtual fraud log 400. The virtual fraud log 400 is a virtual log including an attack log by an insider culprit.

The log embedding unit 123 may embed the specific operation log in the target operation log. The log embedding unit 123 may omit embedding the peripheral log 320 in the operation log 300.

The object condition information 200 is a condition used by the object search unit 111 to narrow down objects. As a specific example, the object condition information 200 is a location where an electronic device is located or an intended use of an electronic device when the objects are electronic devices, and a folder where an electronic file is stored or a confidentiality-related word used in the name of an electronic file when the objects are electronic files.

The user attribute information 210 is information that indicates the attribute of each user. The attribute is information that classifies each user and, as a specific example, is a combination of belonging company, belonging department, position, and years of service. The position is, as a specific example, executive officer, department manager, or section manager.

The malicious operation information 220 indicates a list of malicious operations. As a specific example, when the objects are electronic files, the malicious operation information 220 includes information that indicates each of Universal Serial Bus (USB) output, Internet transmission, local saving, and printing.

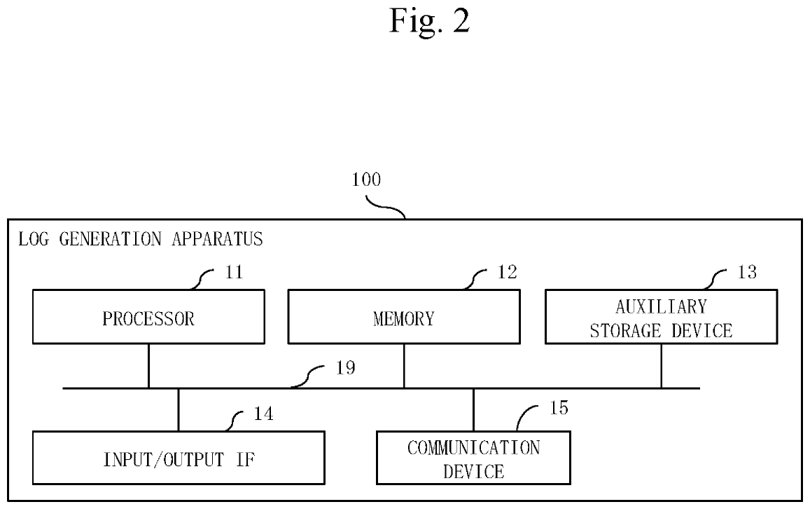

FIG. 2 illustrates an example of a hardware configuration of the log generation apparatus 100 according to this embodiment. The log generation apparatus 100 is composed of a computer. The log generation apparatus 100 may be composed of a plurality of computers.

As illustrated in this figure, the computer includes hardware such as a processor 11, a memory 12, an auxiliary storage device 13, an input/output interface (IF) 14, and a communication device 15. These hardware components are connected with one another through a signal line 19.

The processor 11 is an integrated circuit (IC) that performs operational processing, and controls the hardware included in the computer. The processor 11 is, as a specific example, a central processing unit (CPU), a digital signal processor (DSP), or a graphics processing unit (GPU).

The log generation apparatus 100 may include a plurality of processors as an alternative to the processor 11. The plurality of processors share the role of the processor 11.

The memory 12 is, typically, a volatile storage device. The memory 12 is also called a main storage device or a main memory. The memory 12 is, as a specific example, a random access memory (RAM). Data stored in the memory 12 is saved in the auxiliary storage device 13 as necessary.

The auxiliary storage device 13 is, typically, a non-volatile storage device. The auxiliary storage device 13 is, as a specific example, a read only memory (ROM), a hard disk drive (HDD), or a flash memory. Data stored in the auxiliary storage device 13 is loaded into the memory 12 as necessary.

The memory 12 and the auxiliary storage device 13 may be configured integrally.

The input/output IF 14 is a port to which an input device and an output device are connected. The input/output IF 14 is, as a specific example, a USB terminal. The input device is, as a specific example, a keyboard and a mouse. The output device is, as a specific example, a display.

The communication device 15 is a receiver and a transmitter. The communication device 15 is, as a specific example, a communication chip or a network interface card (NIC).

Each unit of the log generation apparatus 100 may use the communication device 15 as appropriate when communicating with other devices or the like. Each unit of the log generation apparatus 100 may accept data via the input/output IF 14, or may accept data via the communication device 15.

The auxiliary storage device 13 stores a log generation program. The log, generation program is a program that causes a computer to execute the functions of each unit included in the log generation apparatus 100. The log generation program is loaded into the memory 12 and executed by the processor 11. The functions of each unit included in the log generation apparatus 100 are realized by software.

Data used when the log generation program is executed, data obtained by executing the log generation program, and so on are stored in a storage device as appropriate. Each unit of the log generation apparatus 100 uses the storage device as appropriate. As a specific example, the storage device is composed of at least one of the memory 12, the auxiliary storage device 13, a register in the processor 11, and a cache memory in the processor 11. Data and information may have substantially the same meaning. The storage device may be independent of the computer. The storage device stores the object condition information 200, the user attribute information 210, the malicious operation information 220, and the operation log 300. Each of the object condition information 200, the user attribute information 210, the malicious operation information 220, and the operation log 300 may be arranged as a database.

The functions of the memory 12 and the auxiliary storage device 13 may be realized by other storage devices.

The log generation program may be recorded in a computer readable non-volatile recording medium. The non-volatile recording medium is, as a specific example, an optical disc or a flash memory. The log generation program may be provided as a program product.

### Description of Operation

A procedure for operation of the log generation apparatus 100 is equivalent to a log generation method. A program that realizes the operation of the log generation apparatus 100 is equivalent to the log generation program. The operation of the log generation apparatus 100 when the objects are electronic files will be described below.

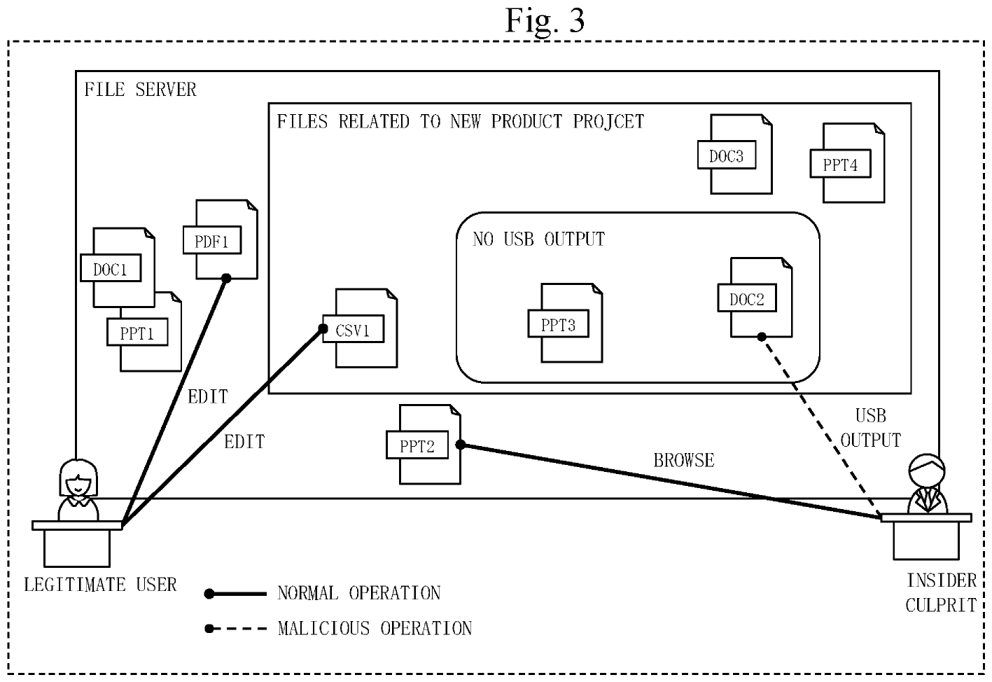

FIG. 3 is a figure that schematically describes internal fraud. In this figure, a file server stores files, and the files are classified as appropriate. “Files related to new product project” are a group of files that indicates information related to a new product project, and it is assumed that the files belonging to “files related to new product project” have a high degree of confidentiality. “No USB output” indicates files that have not been output to a USB flash drive at least in the time range indicated by the operation log 300 among the files belonging to “files related to new product project”, The log generation apparatus 100 may use the operation log 300 to check whether a file falls under “no USB output”. As a specific example, a file belonging to “no USB output” is used to reproduce at least one of internal fraud in which a confidential file that is not normally output to USB is output to a USB flash drive and internal fraud in which a user who normally does not access the confidential file accesses the confidential file and outputs the confidential file to a USB flash drive. A legitimate user is a user who does not perform a malicious operation. An insider culprit is a user who performs a malicious operation. The insider culprit may perform a normal operation. The log generation apparatus 100 assumes that internal fraud has occurred by virtually treating a certain user as the insider culprit. The insider culprit is equivalent to the target user. The log generation apparatus 100 reproduces internal fraud that is performed within the scope of access privilege.

This figure indicates a situation where a file DOC2 is a confidential file that is not normally output to a USB flash drive, but the insider culprit performs internal fraud to output the file DOC2 to a USB flash drive.

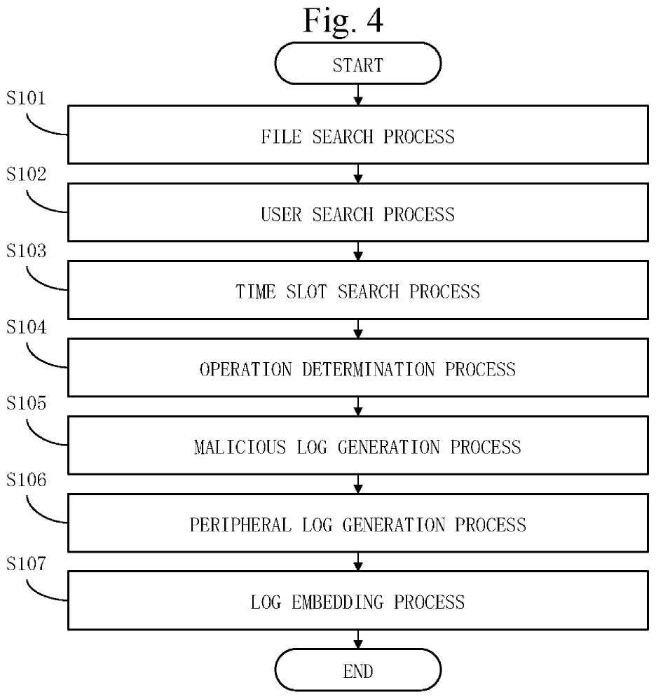

FIG. 4 is a flowchart illustrating an example of the operation of the log generation apparatus 100. Referring to this figure, the operation of the log generation apparatus 100 will be described.

### Step S101: File Search Process

The object search unit 111 determines, as a target file, a file to be the target on which internal fraud is performed, based on the operation log 300.

### Step S102: User Search Process

The user search unit 112 determines, as a target user, a user who performs the internal fraud, based on the operation log 300.

### Step S103: Time Slot Search Process

The time slot search unit 113 determines, as a target time slot, a time slot in which the target user performs the internal fraud, based on the operation log 300.

### Step S104: Operation Determination Process

The malicious log generation unit 121 determines, as a target malicious operation, a malicious operation on the target file, based on the malicious operation information 220.

### Step S105: Malicious Log Generation Process

The malicious log generation unit 121 generates a malicious log 310 indicating that the target user has performed the target malicious operation on the target file in the target time slot.

### Step S106: Peripheral Log Generation Process

The peripheral log generation unit 122 generates a peripheral log 320 indicating what has been performed by the target user in the periphery of the target file in a time slot in the periphery of the target time slot.

### Step S107: Log Embedding Process

The log embedding unit 123 embeds the malicious log 310 and the target peripheral log 320 in the operation log 300 as operations that the target user has performed in the target time slot and in the periphery of the target time slot, so as to generate a virtual fraud log 400.

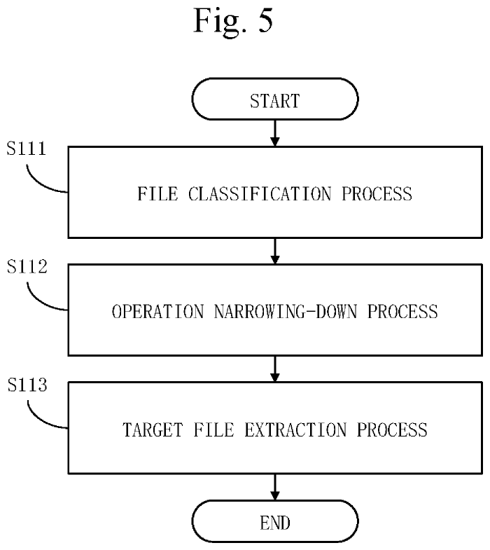

FIG. 5 is a flowchart illustrating an example of operation of the object search unit 111. Referring to this figure, the operation of the object search unit 111 will be described.

### Step S111: File Classification Process

The object search unit 111 classifies the files owned by the target system into categories according to the tendency of access to the files and determines, as a target category, a category to be the target based on the operation log 300. As a specific example, the categories include “files not accessed by anyone”, “files not edited by anyone”, “files accessed for read only by prescribed users or users belonging to prescribed groups”,“files edited only by prescribed users or users belonging to prescribed groups”, “files accessed for read only by specific users”, and “files edited only by specific users”.

Files accessed or edited by many people are considered to have a low degree of confidentiality. Therefore, the object search unit 111 selects, as the target category, a category that is accessed by limited users.

### Step S112: Operation Narrowing-Down Process

The object search unit 111 narrows down the files belonging to the target category to files on which a prescribed malicious operation has not been performed. The object search unit 111 may refer to the malicious operation information 220 to determine the prescribed malicious operation. Prescribed malicious operations may vary depending on the attribute of a user, the property of a file, or the like. As a specific example, it may be arranged that locally saving a file F1 by an executive officer A is not a prescribed malicious operation, but locally saving the file F1 by a section manager B is a prescribed malicious operation. It may be arranged that printing the file F1 is not a prescribed malicious operation, but printing a file F2 is a prescribed malicious operation.

### Step S113: Target File Extraction Process

The object search unit 111 extracts, as a target file, a file whose file name includes a prescribed word, a file stored in a directory whose directory name includes a prescribed word, or the like from the files that remain after the process in the preceding step. As a specific example, the file name or the directory name includes at least one of the terms “confidential internal use only”, “confidential”, “strictly confidential”, “power generating plant”, “new product project”, “plan”, and “specifications”.

The object search unit 111 may extract a plurality of files. Instead of a file, the object search unit 111 may extract a file set composed of a series of files accessed in a certain period of time. When the object search unit 111 extracts a file set, in the subsequent processes the log generation apparatus 100 executes the processes on a per file set basis, instead of on a per file basis.

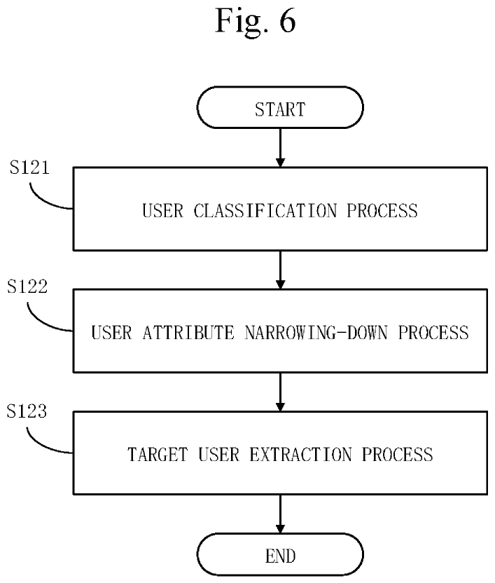

FIG. 6 is a flowchart illustrating an example of operation of the user search unit 112. Referring to this figure, the operation of the user search unit 112 will be described.

### Step S121: User Classification Process

The user search unit 112 classifies each user into a category based on the tendency of access to the target file in the operation log 300, and determines, as a target category, a category to be the target. As a specific example, the categories include “users who never access the target file for read”, “users who access the target file only for read”, and “users who edit the target file”.

### Step S122: User Attribute Narrowing-Down Process

The user search unit 112 uses the user attribute information 210 to narrow down the users belonging to the target category to users who can be the target user. As a specific example, the user search unit 112 narrows down the users to users with relatively low-rank positions or users with relatively short years of service. The user search unit 112 may narrow down the users to users whose combination of information included in user attributes meets a certain condition.

### Step S123: Target User Extraction Process

The user search unit 112 narrows down the users who remain after the process in the preceding step to users who has privilege to access the directory where the target file is located, users who have accessed the directory, or the like, and extracts a target user from the remaining users. The user search unit 112 may extract a plurality of users as target users.

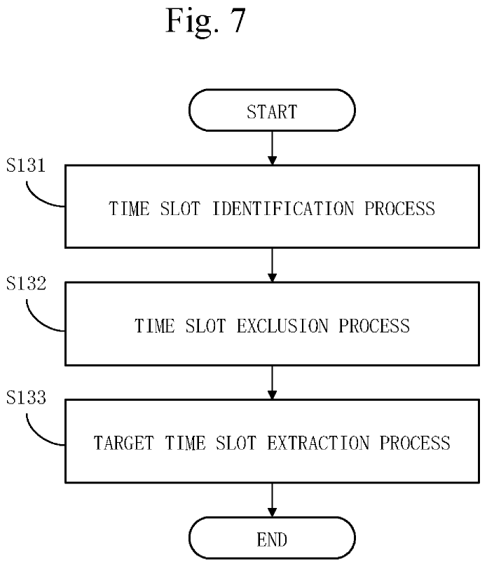

FIG. 7 is a flowchart illustrating an example of operation of the time slot search unit 113. Referring to this figure, the operation of the time slot search unit 113 will be described.

### Step S131: Time Slot Identification Process

The time slot search unit 113 identifies, as specific time slots, time slots in which the target user often accesses a file, based on the operation log 300. The file here may be other than the target file.

### Step S132: Time Slot Exclusion Process

The time slot search unit 113 excludes, from the specific time slots, time slots in which the target user relatively often operates on directories excluding the directory containing the target file and directories in the periphery of this directory, based on the operation log 300. The time slot search unit 113 treats time slots not excluded in this step as remaining time slots.

### Step S133: Target Time Slot Extraction Process

The time slot search unit 113 identifies a time span of file access of the target user based on the operation log 300, and extracts a target time slot from the remaining time slots based on the identified time span. The time span may have an upper limit and a lower limit. As a specific example, the time slot search unit 113 determines the time span based on the types of files or number of files opened by the target user, or the types of files or number of files edited by the target user in a certain period of time.

As a specific example, the time slot search unit 113 treats, as the target time slot, a time after the elapse of the time span from the time at which the target user has accessed a certain file.

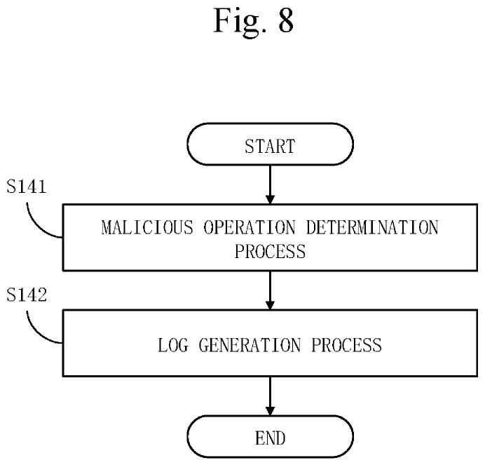

FIG. 8 is a flowchart illustrating an example of operation of the malicious log generation unit 121. Referring to this figure, the operation of the malicious log generation unit 121 will be described.

### Step S141: Malicious Operation Determination Process

The malicious log generation unit 121 refers to the malicious operation information 220 to determine, as a target malicious operation, a malicious operation that the target user performs on the target file. The malicious log generation unit 121 may refer to the operation log 300 to narrow down malicious operations to those that can realistically occur in the target time slot, and determine the target malicious operation from the remaining malicious operations.

### Step S142: Log Generation Process

The malicious log generation unit 121 generates a malicious log 310 indicating that the user has performed the target malicious operation on the target file in the time slot. As a specific example, the malicious log 310 includes a time stamp, the name of the target file, the name of the target user, and information indicating the target malicious operation.

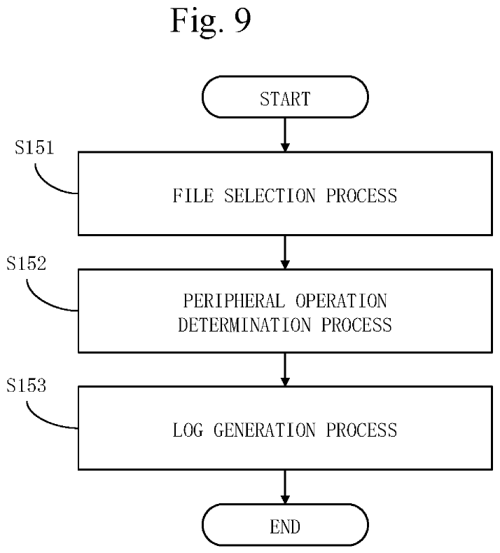

FIG. 9 is a flowchart illustrating an example of the peripheral log generation unit 122. Referring to this figure, the operation of the peripheral log generation unit 122 will be described.

### Step S151: File Selection Process

The peripheral log generation unit 122 selects one or more files from among files, excluding the target file, in the directory where the target file is located and files included in directories in the periphery of this directory.

### Step S152: Peripheral Operation Determination Process

The peripheral log generation unit 122 determines, as a target peripheral operation, a normal operation on the selected file. The target peripheral operation is an operation that is not a malicious operation. The peripheral log generation unit 122 may refer to at least one of the operation log 300 and the malicious operation information 220 as appropriate to determine a target peripheral operation.

### Step S153: Log Generation Process

The peripheral log generation unit 122 generates a peripheral log 320 indicating that the target user has performed the target peripheral operation before or after the time slat of the malicious log 310.

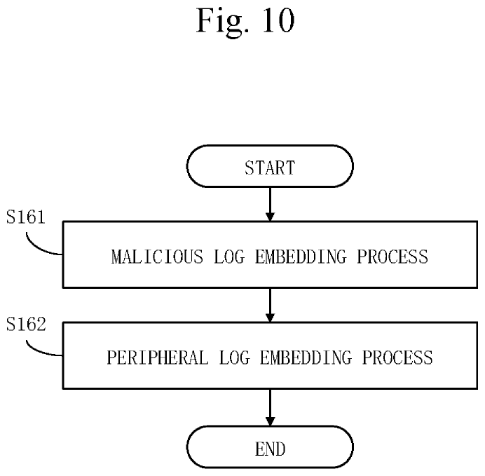

FIG. 10 is a flowchart illustrating an example of operation of the log embedding unit 123. Referring to this figure, the operation of the log embedding unit 123 will be described.

### Step S161: Malicious Log Embedding Process

The log embedding unit 123 embeds the malicious log 310 in the operation log 300 so that the operation indicated by the malicious log 310 appears to have been performed in the target time slot.

### Step S162: Peripheral Log Embedding Process

The log embedding unit 123 embeds the peripheral log 320 in the operation log 300 as appropriate to generate a virtual fraud log 400.

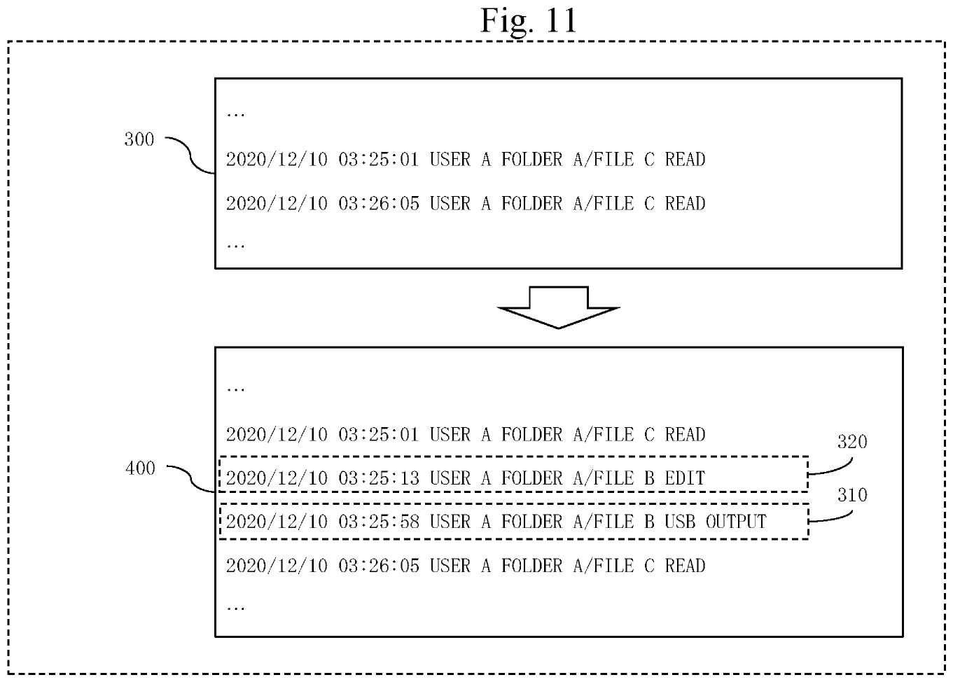

FIG. 11 illustrates a specific example of the operation log 300 and the virtual fraud log 400 corresponding to the operation log 300. In this example, the log generation apparatus 100 embeds a log indicating an operation by a user A to edit a file B in the operation log 300 as the peripheral log 320, and embeds a log indicating an operation by the user A to output the file B to a USB flash drive in the operation log 300 as the malicious log 310.

### Description of Effects of Embodiment 1

As described above, according to this embodiment, a virtual insider attack log corresponding to the environment of a client can be automatically generated.

### Other Configurations

### Variation 1

The malicious log generation unit 121 may generate the malicious log 310 by changing part of the operation log 300.

The peripheral log generation unit 122 may generate the peripheral log 320 by changing part of the operation log 300.

### Variation 2

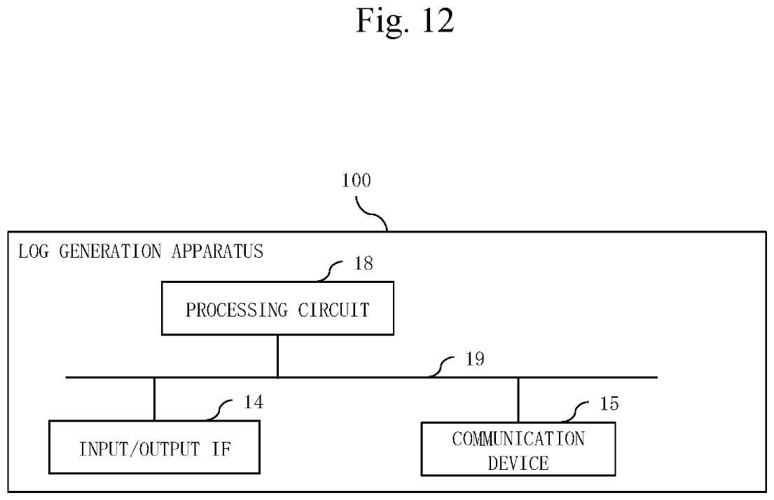

FIG. 12 illustrates an example of a hardware configuration of the log generation apparatus 100 according to this variation.

As illustrated in this figure, the log generation apparatus 100 includes a processing circuit 18 in place of at least one of the processor 11, the memory 12, and the auxiliary storage device 13.

The processing circuit 18 is hardware that realizes at least part of the units included in the log generation apparatus 100.

The processing circuit 18 may be dedicated hardware, or may be a processor that executes programs stored in the memory 12.

When the processing circuit 18 is dedicated hardware, the processing circuit 18 is, as a specific example, a single circuit, a composite circuit, a programmed processor, a parallel-programmed processor, an application specific integrated circuit (AMC), a field programmable gate array (FPGA), or a combination of these.

The log generation apparatus 100 may include a plurality of processing circuits as an alternative to the processing circuit 18. The plurality of processing circuits share the role of the processing circuit 18.

In the log generation apparatus 100, some functions may be realized by dedicated hardware, and the remaining functions may be realized by software or firmware.

As a specific example, the processing circuit 18 is realized by hardware, software, firmware, or a combination of these.

The processor 11, the memory 12, the auxiliary storage device 13, and the processing circuit 18 are collectively called “processing circuitry”. That is, the functions of the functional components of the log generation apparatus 100 are realized by the processing circuitry.

### Other Embodiments

Embodiment 1 has been described, and portions of this embodiment may be implemented in combination. Alternatively, this embodiment may be partially implemented. Alternatively, this embodiment may be modified in various ways as necessary, and may be implemented as a whole or partially in any combination.

The embodiment described above is an essentially preferable example, and is not intended to limit the present disclosure s well as the applications and scope of uses of the present disclosure. The procedures described using the flowcharts or the like may be modified as appropriate.

### REFERENCE SIGNS LIST

1: processor, 12: memory, 13: auxiliary storage device, 14: input/output IF, 15: communication device, 18: processing circuit, 19: signal line, 100: log generation apparatus, 110: log analysis unit, 111: object search unit, 112: user search unit, 113: time slot search unit, 120: log generation unit, 121: malicious log generation unit, 122: peripheral log generation unit, 123: log embedding unit, 200: object condition information, 210: user attribute information, 220: malicious operation information, 300: operation log, 310: malicious log, 320: peripheral log, 400: virtual fraud log.

1. A log generation apparatus in a target system that owns objects, the log generation apparatus comprising
processing circuitry to:
use a target operation log to search for a target object from among the objects owned by the target system, the target operation log being a log of operations actually performed on the objects owned by the target system;
use the target operation log to search for, as a target user, a user who can operate the target object from among users of the target system; and
receive specific operation information indicating a specific operation that a specific user performs in the target system, and use the specific operation information and the target operation log to generate a specific operation log, the specific operation log being a virtual log indicating a specific operation that the target user has performed on the target object.

2. The log generation apparatus according to claim 1,
wherein the processing circuitry uses the target operation log to search for, as a target time slot, a time slot in which an operation indicated by the specific operation log has been performed, and
treats the operation indicated by the specific operation log as having been performed in the target time slot.

3. The log generation apparatus according to claim 2,
wherein the processing circuitry embeds the specific operation log in the target operation log.

4. The log generation apparatus according to claim 3,
wherein the processing circuitry generates a peripheral log, the peripheral log being a virtual log indicating a peripheral operation that is an operation other than the specific operation and performed by the target user in a periphery of a location where the target object is stored in a time slot in a periphery of the target time slot, and
embeds the peripheral log in the target operation log.

5. The log generation apparatus according to claim 1,
wherein the processing circuitry searches for the target object, based on a degree of confidentiality of each object owned by the target system.

6. The log generation apparatus according to claim 1,
wherein the processing circuitry uses user attribute information indicating an attribute of each user of the target system so as to search for the target user.

7. The log generation apparatus according to claim 1,
wherein the objects are electronic files.

8. The log generation apparatus according to claim 1,
wherein the objects are electronic devices.

9. A log generation method in a target system that owns objects, the log generation method comprising:
using a target operation log to search for a target object from among the objects owned by the target system, the target operation log being a log of operations actually performed on the objects owned by the target system;
using the target operation log to search for, as a target user, a user who can operate the target object from among users of the target system; and
receiving specific operation information indicating a specific operation that a specific user performs in the target system, and using the specific operation information and the target operation log to generate a specific operation log, the specific operation log being a virtual log indicating a specific operation that the target user has performed on the target object.

10. A non-transitory computer readable medium storing a log generation program in a target system that owns objects, the log generation program causing a log generation apparatus, which is a computer, to execute:
an object search process of using a target operation log to search for a target object from among the objects owned by the target system, the target operation log being a log of operations actually performed on the objects owned by the target system;
a user search process of using the target operation log to search for, as a target user, a user who can operate the target object from among users of the target system; and
a specific operation log generation process of receiving specific operation information indicating a specific operation that a specific user performs in the target system, and using the specific operation information and the target operation log to generate a specific operation log, the specific operation log being a virtual log indicating a specific operation that the target user has performed on the target object.
